(19) United States
(12) Patent Application Publication
(10) Pub. No.: US 2012/0164361 A1
(43) Pub. Date: Jun. 28, 2012

(54) High Viscosity and Multiple Component Polyurethane Container and Its Preparation Methods thereof

(75) Inventor: MENQ-FONG SHIEH, Tainan (TW)

(73) Assignee: FOAMTECH POLYMER CO., LTD., Hui-zhou (CN)

(21) Appl. No.: 12/977,055

(22) Filed: Dec. 22, 2010

(51) Int. Cl. B32B 1/02; B29C 41/08

(52) U.S. Cl. 428/35.7; 264/309

(57) ABSTRACT

The invention discloses a high viscosity and multiple component polyurethane container, wherein the container includes five components of A, B, C, D, E, and the weight ratio of A, B, C, D, E components is 90 to 100:75 to 90:100 to 200:20 to 100:0.5 to 3. The foresaid component A includes polyether polyol and filler, wherein the filler is selected from one or more from mica powder, talc powder and calcium carbonate; the foresaid component B includes isocyanate and filler, wherein the filler is selected from one or more from mica powder, talc powder and calcium carbonate; the foresaid component C includes quartz sand or river sand; the foresaid component D includes bamboo loop or a hoop; the foresaid component E includes glass fiber or chemical fiber. The container of the invention has the following advantages: hard to damage, easy to transport, quick prototyping, various shapes in production and environmental.

### TECHNICAL FIELD

The invention relates to a high viscosity and multiple component polyurethane container, and also relates to its preparation methods thereof.

### BACKGROUND ART

With the continuous improvement of living standards, more and more people began to use flowers to beautify living spaces. Meanwhile, the flower is also widely used to beautify the urban environment, especially in the major holiday or significant event; it often requires a million pots of flowers, which demands a lot of pots.

Nowadays, most currently used are ceramic flower pots, ceramic pots are eco-friendly and conducive to the growth of the flowers. However, ceramic flower pots also have some disadvantages. First of all, ceramic flower pots are made of clay or kaolin clay firing, when the pots are in great demand, it shall need to consume a large amount of natural resources, and ultimately increase costs and restrict output owing to the shortage of natural resources. Secondly, it needs a long time to porcelain bodies at high temperature above 1000 degrees Celsius (hereinafter referred to as “° C.”) fired to make ceramic pots and consumes a lot of energy. Thirdly, the production of ceramic pots are complex, through pan off, mud pile, throwing, printing blank, repairing blank, pressing down the water, drawing blank, glazing and firing pottery, ceramics and other processes, especially for the large flower pots, firing is very difficult, and the finished product rate is low. As we all know, ceramic pots are fragile, which will bring great troubles for carrying ceramic pots.

Because ceramic pots with these shortcomings, there are some pots made by other materials, such as wooden or plastic flower pots. Among them, the wooden flower pots are expensive, they are not widely used; durable but lightweight, but the plastic pots are impermeable, impervious, they are difficult to adapt to growing flowers, and long-term in nature they cannot be completely degraded, causing “white pollution.”

### CONTENTS OF THE INVENTION

The purpose of this invention is to provide a high viscosity and multiple component polyurethane container which is simple making and non-fragile, with the hard filler in its soft feasible receipt to enhance the physicality and weight of the products and so on. The foresaid container includes five components of A, B, C, D, E, and the weight ratio of A, B, C, D, E components is 90 to 100:75 to 90:100 to 200:20 to 100:0.5 to 3. Where, the foresaid component A includes polyether polyol and filler, wherein the foresaid filler is selected from one or more from mica powder, talc powder and calcium carbonate; the foresaid component B includes isocyanate and filler, wherein the foresaid filler is selected from one or more from mica powder, talc powder and calcium carbonate; the foresaid component C includes quartz sand or river sand; the foresaid component D includes bamboo loop or a hoop; the foresaid component E includes glass fiber or chemical fiber.

Optimally, the weight ratio of the foresaid A, B, C, D, E components is 100:80:130:30:2.

Optimally, the foresaid polyether polyol is propylene chloride homopolymer and propylene chloride graft copolymerization polyhydric alcohol.

Optimally, the foresaid isocyanate is 4,4′-diphenylmethane diisocyanate (MDI) or Toluene diisocyanate (TDI).

Optimally, the weight ratio of the foresaid polyether polyol and filler is 30 to 60:70 to 40; while the weight ratio of the foresaid isocyanate and filler is 30 to 60:70 to 40.

Accordingly, the invention is also providing a preparation method to produce the high viscosity and multiple component polyurethane container, the preparation of a container comprises the following steps:

A. Spray a layer of in-mold coating on the contain mold evenly, and then put the foresaid contain mold into the oven in 35 degrees Celsius to 55 degrees Celsius temperature dried the foresaid in-mold coating;
B. put the component D in the molding making spot which is in the inside of oral part of the foresaid contain mold;
C. mix the component A and component B with a certain ratio and affuse them into the mold evenly, then evenly die-cast or shake and spread in the inside wall of the foresaid container mold, then put the foresaid contain mold into the aluminum frame; and
D. spread the component C and component E in the inside wall of the foresaid container mold, then close a part of the foresaid contain mold, depose and open the foresaid contain mold to take the container;

The foresaid container includes five components of A, B, C, D, E, and the weight ratio of A, B, C, D, E components is 90 to 100:75 to 90:100 to 200:20 to 100:0.5 to 3. Where, the foresaid component A includes polyether polyol and filler, wherein the foresaid filler is selected from one or more from mica powder, talc powder and calcium carbonate; the foresaid component B includes isocyanate and filler, wherein the foresaid filler is selected from one or more from mica powder, talc powder and calcium carbonate; the foresaid component C includes quartz sand or river sand; the foresaid component D includes bamboo loop or a hoop; the foresaid component E includes glass fiber or chemical fiber.

Optimally, the weight ratio of the foresaid A, B, C, D, E components is 100:80:130:30:2.

Optimally, the foresaid in-mold casting is water-borne acrylic coating or oil acrylic coating; the foresaid polyether polyol is propylene chloride homopolymer and propylene chloride graft copolymerization polyhydric alcohol; the foresaid isocyanate is 4,4′-diphenylmethane diisocyanate (MDI) or Toluene diisocyanate (TDI).

The weight ratio of the foresaid polyether polyol and filler is 30 to 60:70 to 40; while the weight ratio of the foresaid isocyanate and filler is 30 to 60:70 to 40.

Optimally, the standing time of the foresaid step D is ten (10) to fifteen (15) minutes.

The container of the invention has the following advantages: not easy to damage, easy to transport, quick prototyping, various shapes in production and environmental.

### MODE OF CARRYING OUT THE INVENTION

To give a specific way of implementing the inspector to learn more about the structure of the present invention, features and other purposes, now we combined with the attached detail below of the good implementation of the case, the better implementation of the cases described in the present invention only for the technical solution, it does not limit the invention.

### Example 1

According to the following formula for the preparation the high viscosity and multiple component polyurethane container:

| | | |
|---|---|---|
| Propylene chloride homopolymer polyhydric alcohol | 45 | parts by weight |
| Propylene chloride graft copolymerization polyhydric | 10 | parts by weight |
| alcohol. | | |
| Mica powder | 10 | parts by weight |
| Calcium carbonates | 35 | parts by weight |
| Toluene disocyanate (TDI) | 40 | parts by weight |
| Mica powder | 20 | parts by weight |
| Calcium carbonates | 20 | parts by weight |
| Quartz | 130 | parts by weight |
| Bamboo bop | 30 | parts by weight |
| Chemical fiber | 2 | parts by weight |

Put the propylene chloride homopolymer polyhydric alcohol, propylene chloride graft copolymerization polyhydric alcohol, mica powder, calcium carbonates, toluene diisocyanate (TDI) in the reserve tank of the placer (disclosed in CN200810066523.0, CN200820095800.6 and CN200720171026.8); spray a layer of oil acrylic coating as in-mold coating on the contain mold evenly, and then put the foresaid contain mold into the oven in 55 degrees Celsius temperature to dry the foresaid in-mold coating; put the bamboo loop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then D. spread the quartz sand and glass fiber in the inside wall of the foresaid container mold, then close the container mold, depose at 15 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 2

According to the following formula for the preparation the high viscosity and multiple component polyurethane container:

| | | |
|---|---|---|
| Propylene chloride homopolymer polyhydric alcohol | 40 | parts by weight |
| Propylene chloride graft copolymerization polyhydric | 20 | parts by weight |
| alcohol. | | |
| Mica powder | 40 | parts by weight |
| 4,4′-diphenylmethane diisocyanate (MDI) | 48 | parts by weight |
| Mica powder | 32 | parts by weight |
| quartz sand | 130 | parts by weight |
| Bamboo bop | 30 | parts by weight |
| Chemical fiber | 1 | parts by weight |

Put the propylene chloride homopolymer polyhydric alcohol, propylene chloride graft copolymerization polyhydric alcohol, mica powder, toluene diisocyanate (TDI) in the reserve tank of the placer (disclosed in CN200810066523.0, CN200820095800.6 and CN200720171026.8); spray a layer of water-borne acrylic coating as in-mold coating on the contain mold evenly, and then put the foresaid contain mold into the oven in 50° C. temperature to dry the foresaid in-mold coating; put the bamboo loop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then spread the quartz sand and glass fiber in the inside wall of the foresaid container mold, then close the container mold, depose at 12 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 3

According to the following formula for the preparation the high viscosity and multiple component polyurethane container:

| | | |
|---|---|---|
| Propylene chloride homopolymer polyhydric alcohol | 12 | parts by weight |
| Propylene chloride graft copolymerization polyhydric | 15 | parts by weight |
| alcohol. | | |
| Talc powder | 63 | parts by weight |
| Toluene disocyanate (TDI) | 22 | parts by weight |
| Talc powder | 51 | parts by weight |
| River sand | 200 | parts by weight |
| A hoop | 100 | parts by weight |
| Glass fiber | 3 | parts by weight |

Put the propylene chloride homopolymer polyhydric alcohol, propylene chloride graft copolymerization polyhydric alcohol, talc powder, toluene diisocyanate (TDI) in the reserve tank of the placer (disclosed in CN200810066523.0, CN200820095800.6 and CN200720171026.8); spray a layer of oil acrylic coating as in-mold coating on the contain mold evenly, and then put the foresaid contain mold into the oven in 55° C. temperature to dry the foresaid in-mold coating; put the hoop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then spread the quartz sand and glass fiber in the inside wall of the foresaid container mold, then close the container mold, depose at 15 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 4

According to the following formula for the preparation the high viscosity and multiple component polyurethane container:

| | | |
|---|---|---|
| Propylene chloride homopolymer polyhydric alcohol | 20 | parts by weight |
| Propylene chloride graft copolymerization polyhydric | 10 | parts by weight |
| alcohol. | | |
| Calcium carbonates | 70 | parts by weight |
| Toluene disocyanate (TDI) | 28 | parts by weight |
| Calcium carbonates | 52 | parts by weight |
| River sand | 100 | parts by weight |
| A hoop | 20 | parts by weight |
| Chemical fiber | 0.5 | parts by weight |

Put the propylene chloride homopolymer polyhydric alcohol, propylene chloride graft copolymerization polyhydric alcohol, Calcium carbonates, toluene diisocyanate (TDI) in the reserve tank of the placer (disclosed in CN200810066523.0, CN200820095800.6 and CN200720171026.8); spray a layer of water-borne acrylic coating as in-mold coating on the contain mold evenly, and then put the foresaid contain mold into the oven in 35° C. temperature to dry the foresaid in-mold coating; put the hoop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then spread the quartz sand and glass fiber in the inside wall of the foresaid container mold, then close the container mold, depose at 12 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 5

According to the following formula for the preparation the high viscosity and multiple component polyurethane container:

| | | |
|---|---|---|
| Propylene chloride homopolymer polyhydric alcohol | 35 | parts by weight |
| Propylene chloride graft copolymerization polyhydric | 15 | parts by weight |
| alcohol. | | |
| Mica powder | 25 | parts by weight |
| Talc powder | 25 | parts by weight |
| 4,4′-diphenylmethane diisocyanate (MDI) | 45 | parts by weight |
| Mica powder | 20 | parts by weight |
| Talc powder | 25 | parts by weight |
| River sand | 200 | parts by weight |
| A hoop | 100 | parts by weight |
| Glass fiber | 2 | parts by weight |

Put the propylene chloride homopolymer polyhydric alcohol, propylene chloride graft copolymerization polyhydric alcohol, mica powder, talc powder, toluene diisocyanate (TDI) in the reserve tank of the placer (disclosed in CN200810066523.0, CN200820095800.6 and CN200720171026.8); spray a layer of oil acrylic coating as in-mold coating on the contain mold evenly, and then put the foresaid contain mold into the oven in 55 degrees Celsius temperature to dry the foresaid in-mold coating; put the hoop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then D. spread the quartz sand and glass fiber in the inside wall of the foresaid container mold, then close the container mold, depose at 15 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 6

According to the following formula for the preparation the high viscosity and multiple component polyurethane container:

| | | |
|---|---|---|
| Propylene chloride homopolymer polyhydric alcohol | 35 | parts by weight |
| Propylene chloride graft copolymerization polyhydric | 10 | parts by weight |
| alcohol. | | |
| Mica powder | 10 | parts by weight |
| Calcium carbonates | 35 | parts by weight |
| Toluene diisocyanate (TDI) | 40 | parts by weight |
| Mica powder | 20 | parts by weight |
| Calcium carbonates | 20 | parts by weight |
| Quartz | 150 | parts by weight |
| Bamboo bop | 80 | parts by weight |
| Chemical fiber | 2 | parts by weight |

Put the propylene chloride homopolymer polyhydric alcohol, propylene chloride graft copolymerization polyhydric alcohol, mica powder, calcium carbonates, toluene diisocyanate (TDI) in the reserve tank of the placer (disclosed in CN200810066523.0, CN200820095800.6 and CN200720171026.8); spray a layer of oil acrylic coating as in-mold coating on the contain mold evenly, and then put the foresaid contain mold into the oven in 55° C. temperature to dry the foresaid in-mold coating; put the bamboo loop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then spread the quartz sand and glass fiber in the inside wall of the foresaid container mold, then close the container mold, depose at 15 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

### Example 7

According to the following formula for the preparation the high viscosity and multiple component polyurethane container:

| | | |
|---|---|---|
| Propylene chloride homopolymer polyhydric alcohol | 35 | parts by weight |
| Propylene chloride graft copolymerization polyhydric | 10 | parts by weight |
| alcohol. | | |
| Mica powder | 10 | parts by weight |
| Calcium carbonates | 35 | parts by weight |
| 4,4′-diphenylmethane diisocyanate (MDI) | 40 | parts by weight |
| Mica powder | 20 | parts by weight |
| Calcium carbonates | 20 | parts by weight |
| Quartz | 150 | parts by weight |
| A hoop | 80 | parts by weight |
| Glass fiber | 2 | parts by weight |

Put the propylene chloride homopolymer polyhydric alcohol, propylene chloride graft copolymerization polyhydric alcohol, mica powder, calcium carbonates, toluene diisocyanate (TDI) in the reserve tank of the placer (disclosed in CN200810066523.0, CN200820095800.6 and CN200720171026.8); spray a layer of oil acrylic coating as in-mold coating on the contain mold evenly, and then put the foresaid contain mold into the oven in 55° C. temperature to dry the foresaid in-mold coating; put the hoop in the molding making spot which is in the inside of oral part of the foresaid contain mold, and mix the component A and component B and affuse them into the mold evenly, then evenly die-cast or shake and spread in the inside wall of the foresaid container mold, then put the foresaid container mold into the aluminum frame; and then spread the quartz sand and glass fiber in the inside wall of the foresaid container mold, then close the container mold, depose at 15 minutes and open the foresaid container mold to take the container.

The container of the example is able to shape in perfusion molding at the normal temperature, therefore it shapes faster, takes less energy and could make up with various colors and effects, while the current ceramic pots required to be fired above 1000° C., and the dye stuff needed to be able to bear the temperature above 1000° C., therefore the choices for the colors are limited. Secondly, the intensity of the container of the invention is better, for it could be throw in 60 centimeter without protections and keep intact, while the current ceramic containers could not be threw without protections.

It requires to declare that the above contents and specific way of implementing the invention is intended to prove that the present invention is the practical application of technical solutions, it should not be construed as limited the protection scope of this invention. The technical staff in the field of the spirit and principles of this invention can use for various modifications, equivalent replacement or improvement. The extent of protection of this invention is subject to the attached claims.

What is claimed is:

1. A high viscosity and multiple component polyurethane container, wherein the foresaid container includes five components of A, B, C, D, E, and the weight ratio of A, B, C, D, E components is 90 to 100:75 to 90:100 to 200:20 to 100:0.5 to 3. Where,
The foresaid component A includes polyether polyol and filler, wherein the foresaid filler is selected from one or more from mica powder, talc powder and calcium carbonate;
The foresaid component B includes isocyanate and filler, wherein the foresaid filler is selected from one or more from mica powder, talc powder and calcium carbonate;
The foresaid component C includes quartz sand or river sand;
The foresaid component D includes bamboo loop or a hoop;
The foresaid component E includes glass fiber or chemical fiber.

2. The container as set forth in claim 1, characterized in that the weight ratio of the foresaid A, B, C, D, E components is 100:80:130:30:2.

3. The container as set forth in claim 1, characterized in that the foresaid polyether polyol is propylene chloride homopolymer and propylene chloride graft copolymerization polyhydric alcohol.

4. The container as set forth in claim 2, characterized in that the foresaid polyether polyol is propylene chloride homopolymer and propylene chloride graft copolymerization polyhydric alcohol.

5. The container as set forth in claim 1, characterized in that the foresaid isocyanate is 4,4′-diphenylmethane diisocyanate (MDI) or Toluene diisocyanate (TDI)

6. The container as set forth in claim 2, characterized in that the foresaid isocyanate is 4,4′-diphenylmethane diisocyanate (MDI) or Toluene diisocyanate (TDI)

7. The container as set forth in claim 3, characterized in that the weight ratio of the foresaid polyether polyol and filler is 30 to 60:70 to 40; while the weight ratio of the foresaid isocyanate and filler is 30 to 60:70 to 40.

8. The container as set forth in claim 4, characterized in that the weight ratio of the foresaid polyether polyol and filler is 30 to 60:70 to 40; while the weight ratio of the foresaid isocyanate and filler is 30 to 60:70 to 40.

9. A preparation methods as set forth in claim 1, the preparation of a container comprises the following steps:
A. Spray a layer of in-mold coating on the contain mold evenly, and then put the foresaid contain mold into the oven in 35 degrees Celsius to 55 degrees Celsius temperature dried the foresaid in-mold coating;
B. put the component D in the molding making spot which is in the inside of oral part of the foresaid contain mold;
C. mix the component A and component B with a certain ratio and affuse them into the mold evenly, then evenly die-cast or shake and spread in the inside wall of the foresaid container mold, then put the foresaid contain mold into the aluminum frame; and
D. spread the component C and component E in the inside wall of the foresaid container mold, then close a part of the foresaid contain mold, depose and open the foresaid contain mold to take the container;
The foresaid container includes five components of A, B, C, D, E, and the weight ratio of A, B, C, D, E components is 90 to 100:75 to 90:100 to 200:20 to 100:0.5 to 3. Where,
The foresaid component A includes polyether polyol and filler, wherein the foresaid filler is selected from one or more from mica powder, talc powder and calcium carbonate;
The foresaid component B includes isocyanate and filler, wherein the foresaid filler is selected from one or more from mica powder, talc powder and calcium carbonate;
The foresaid component C includes quartz sand or river sand; the foresaid component D includes bamboo loop or a hoop; the foresaid component E includes glass fiber or chemical fiber.

10. The preparation methods as set forth in claim 9, characterized in that the weight ratio of the foresaid A, B, C, D, E components is 100:80:130:30:2.

11. The preparation methods as set forth in claim 9, characterized in that the foresaid in-mold casting is water-borne acrylic coating or oil acrylic coating; the foresaid polyether polyol is propylene chloride homopolymer and propylene chloride graft copolymerization polyhydric alcohol; the foresaid isocyanate is 4,4′-diphenylmethane diisocyanate (MDI) or Toluene diisocyanate (TDI).

12. The preparation methods as set forth in claim 10, characterized in that the foresaid in-mold casting is water-borne acrylic coating or oil acrylic coating; the foresaid polyether polyol is propylene chloride homopolymer and propylene chloride graft copolymerization polyhydric alcohol; the foresaid isocyanate is 4,4′-diphenylmethane diisocyanate (MDI) or Toluene diisocyanate (TDI).

13. The preparation methods as set forth in claim 11, characterized in that the weight ratio of the foresaid polyether polyol and filler is 30 to 60:70 to 40; while the weight ratio of the foresaid isocyanate and filler is 30 to 60:70 to 40.

14. The preparation methods as set forth in claim 12, characterized in that the weight ratio of the foresaid polyether polyol and filler is 30 to 60:70 to 40; while the weight ratio of the foresaid isocyanate and filler is 30 to 60:70 to 40.

15. The preparation methods as set forth in claim 9, characterized in that the standing time of the foresaid step D is ten (10) to fifteen (15) minutes.
